(19) United States
(12) Patent Application Publication
(10) Pub. No.: US 2005/0036536 A1
(43) Pub. Date: Feb. 17, 2005

(54) High throughout energy array

(76) Inventor: Edwin A. Lewis, Parks, AZ (US)

Correspondence Address: Brent T Winder;Jones Waldo Holbrook & McDonough, Suite 1500, 170 South Main Street, Salt Lake City, UT, 84101, US

(21) Appl. No.: 10/489,850

(22) PCT Filed: Sep. 18, 2002
(86) PCT No.: PCT/US02/29501

Related U.S. Application Data
(60) Provisional application No. 60/323,203, filed on Sep. 18, 2001.

(51) Int. Cl. G01K 15/00

(52) U.S. Cl. 374/2

(57) ABSTRACT

A device for measuring heat flow from a first, second and third sample. The device includes a sample array. The sample array includes a base, a first receptacle, capable of containing the first sample, coupled to the base; a second receptacle, capable of containing the second sample, coupled to the base; a third receptacle, capable of containing a third sample, coupled to the base; a first sensor, in communication with the first receptacle, which detects a first heat flow from the first sample and converts the first heat flow into a first electronic signal; a second sensor, in communication with the second receptacle, which detects a second heat flow from the second sample and converts the second heat flow into a second electronic signal; and a third sensor, in communication with the third receptacle, which detects a third heat flow from the third sample and converts the third heat flow into a third electronic signal. One or more covers are positioned substantially over the first, second and third receptacles, substantially preventing the influx of air into the first, second and third receptacles. A processor, in communication with the first, second and third sensors, receives the first, second and third electronic signal and converts the first, second and third electronic signals into a readable measurement of heat flow in the first, second and third sample.

### BACKGROUND

Substantial effort and funding are currently being expended in the genomics and proteomics fields with the focus of much of this effort being the discovery of new therapeutic and diagnostic agents. These therapeutic and diagnostic agents may work at the DNA (or RNA) level, the field of genomics, or at the protein level, the field of proteomics. In either case, the activity of a therapeutic and/or diagnostic agent resides in the ability of the drug molecule to bind tightly to a specific target molecule and through this complex formation to alter the function of the target molecule.

Currently there are two prevailing approaches to evaluate how effectively a particular drug binds with a target molecule, such as a nucleic acid or protein: the structural approach and the functional approach. The structural approach is based on predicting the potential of binding interactions from knowledge of the 3-D structures of the interacting molecules. This geometric approach, which evaluates how well the target molecule and drug molecule might fit together, is used to minimize the number of potential drug molecules that should be studied in detail. The functional approach is based on measurement of the change in the biological function of a nucleic acid or protein in the presence of the therapeutic agent.

Both the structural and functional approaches have merit when the structure and/or function of the biopolymer (nucleic acid or protein) are known. However, the product of human genomic and proteomic research is likely to be about 100,000 genes, and as many as 1,000,000 proteins, with most of these molecules of unknown structure and unknown function, thereby rendering these existing approaches less efficient.

An energetics-based approach to screen and to characterize binding interactions between potential therapeutic (or diagnostic) agents and unknown target molecules is therefore very attractive. Energetic instrumentation not only detects the occurrence of these reactions but also the strength of the binding interaction and possibly the rate at which these processes take place. The thermodynamic and kinetic data derived from energetic measurements are not only fundamental to the understanding of the action of a therapeutic agent, but can be used in a predictive fashion to yield new therapeutic agents.

Energetic detection of interactions requires no prior knowledge of the structure or function. Energetic detection of interactions can also be done without labeling of the interacting species (e.g. fluorescent probes, radioactive tags, etc.), which can create artifact signals that are detected or scored in error as significant drug binding. In other words, energetic data is created purely by the drug-target interaction and not by tags or other potentially interfering additions.

Data gathered from energetic detection of interactions between therapeutic or diagnostic agents and target molecules would significantly reduce the overall costs of research, and reduce the time needed for discovery, by accelerating conventional structural and functional based genomic and proteomic research. Specifically the gathered data may be used to create a large-scale energetics database for binding interactions which would add a needed dimension to the structural and functional genomics/proteomic research efforts in drug discovery and design, diagnostics, screening, therapeutics and other practical health care applications.

The current limitation in using an energetic approach to drug design and to screening libraries of compounds for drug activity has been the rather slow rate at which the energetic data could be collected with available calorimetric instruments. Specifically, current calorimeters only have one sample cell and therefore are only capable of testing one sample at a time. As noted above, in human genomic and proteomic research, this would require that approximately 100,000 genes, and as many as 1,000,000 proteins, be tested against equally large numbers of ligand molecules. Thus, under current calorimetry technology, it is not feasible to conduct energetics-based research simply because of the limitations as to the number of samples that can be tested in a reasonable period of time.

Accordingly, a calorimeter that utilized an array of multiple sample cells, and corresponding sensors, thus being capable of high throughput energy detection would be desirable.

In operating a calorimeter having an array of multiple sample cells, and corresponding sensors, another important consideration is the proximity of the sample being tested to a reference. Specifically, in differential calorimetry, it is necessary to have a reference cell proximate the sample cell in order to factor out external environmental conditions. For example, if a user sought to determine the heat flow from a reaction that occurred in water, the user would want a reference cell of water proximate the sample cell to be able to detect what changes in heat flow resulted from changes in room temperature, etc., distinct from the heat flow that occurred as part of the chemical reaction in the sample cell.

The inclusion of a reference cell presents challenges with respect to the efficiency and/or size of the instrument. Specifically, it is desirable to have the reference cell close enough to the sample cell that it is experiencing, as much as possible, the same external conditions as the sample cell. However, simply placing the samples and references in adjacent wells effectively cuts in half the number of samples that can be tested in a given run. Alternatively, in order to compensate for the presence of references, one could construct an array that was capable of testing twice as many samples. However, constructing such a device not only requires more materials, and consequently more expense, but it also requires the device itself be larger and more cumbersome.

A calorimeter having an array of multiple sample cells configured to allow close proximity to reference cells, while at the same time being compact in size, would therefore be desirable.

### BRIEF DESCRIPTION OF THE DRAWINGS

FIG. 1 shows an embodiment of a calorimeter block measurement well array according to the present invention.

FIG. 2 shows an embodiment of the present invention compatible with robotic systems for sample handling.

FIG. 3 is a cross sectional view of a calorimeter block measurement well array according to one embodiment of the present invention.

FIG. 4 shows a block diagram of the calibration heater circuitry according to one embodiment of the present invention

FIG. 5 is a view of a one-piece calorimetric block.

FIG. 6 shows examples of disposable sample vials and the titrant injection means.

FIGS. 7(a) through (c) show titrant injector delivery head designs.

FIG. 8 shows a monolithic energy array detector chip.

FIGS. 9(a)-(b) show examples of insulated covering variations that can be used with the present invention.

FIG. 10 depicts the operation of the airlock covering depicted in FIG. 9(a).

### DETAILED DESCRIPTION OF THE ILLUSTRATED EMBODIMENT(S)

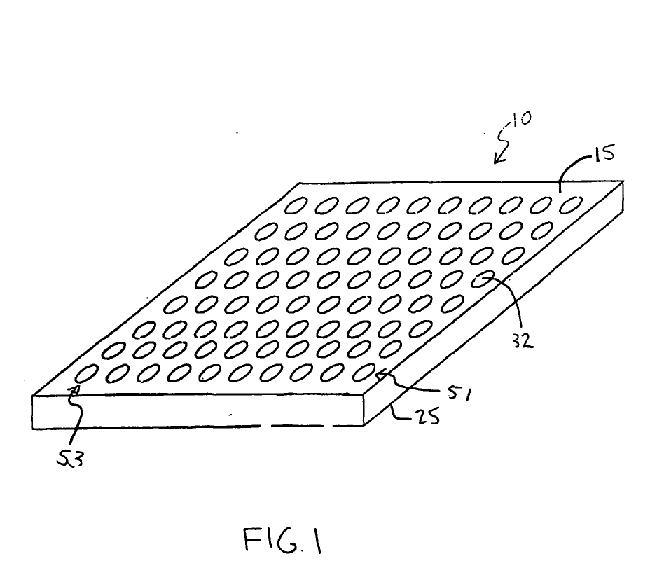

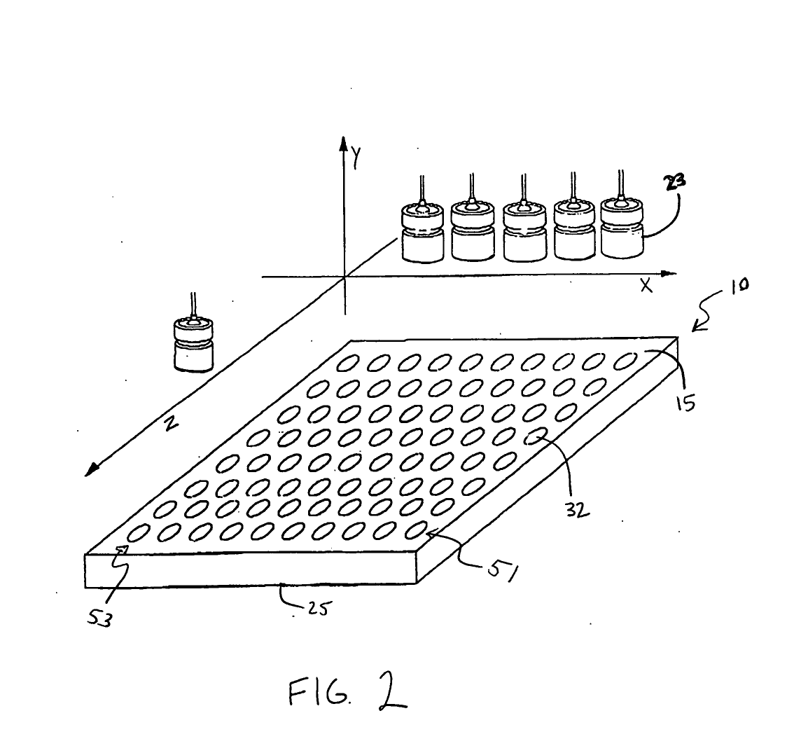

In FIG. 1 is shown a calorimeter block or base 10 having a plurality of measurement wells or receptacles 32. Each measurement well 32 is capable of receiving either a test sample or a reference sample. The array of the measurement wells 32 can employ any geometry consistent with a regular spacing of the measurement wells 32 and a reasonable instrument footprint. It is noted that, with respect to configuration of the measurement wells 32, an important consideration is adequate separation to minimize signal cross talk.

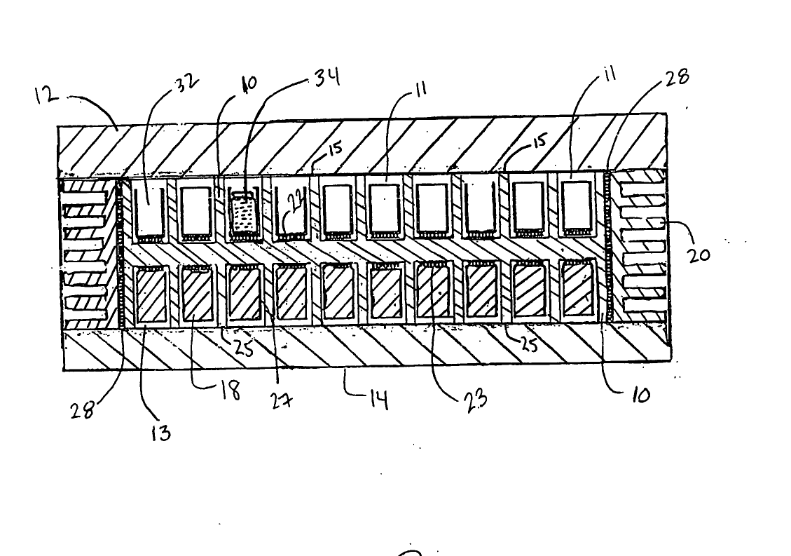

As schematically illustrated in FIG. 2, the array configuration of the measurement wells 32 can be selected to facilitate integration of the instrument with a commercially available robotic system for automated pick and place sample vial 23 handling operations (for example, the RSP 9000 Robotic Sample Processor, available from CAVRO Scientific Instruments of San Jose, Calif.). As would be apparent to one skilled in the art, when robotic sample handling is utilized, the maximal array dimensions must be compatible with the maximal X, Y, and Z axis translations supported by the robotic system. The spacing of the wells 32 should also be compatible with titrant delivery concerns and/or robotics for sample handling.

It is noted that the present invention may be equipped to utilize the standard geometry for 96 well plate readers, etc. used in other common biotech instrumentation and thus take advantage of standard sample and liquid handling systems designed around the 96 well format (for example, the sample formats utilized in instruments made by Microplate Instrument Specialists of Vienna, Va.).

FIG. 3, is a cross-sectional view of one embodiment of a calorimetric block 10 showing a stacked geometry configuration. The calorimetric block 10 comprises multiple upper 11 and lower 13 parallel measurement channels (extending into and out of the page). Within the upper channels 11, are a series of measurement wells or receptacles 32 within which either test samples 34 or reference samples are placed. The measurement wells 32 are each affixed to solid state thermoelectric device (TED) heat flow sensors 22 which are affixed to the calorimeter block 10. The sensors 22, detect heat flow occurring in the measurement wells 32 and then convert the heat flow into an electrical signal, which can then be interpreted by a processor into a readable heat flow measurement.

It is noted that, in this embodiment, the sensors 22 are located beneath the measurement well 32. However, in other embodiments, the sensors 22 could be positioned on the side of the receptacle 32, or in any other position that would allow suitable heat flow detection.

Examples of suitable sensors for use in the present invention include, but are not limited to, the OptoTEC™ Series, Telecom Coolers, and CP Series, available through Melcor of Trenton, N.J.

In the lower channels 13, is a series of reference wells or receptacles 27 in which one or more passive reference samples 18 can be placed. These passive references 18 are in communication with a reference heat flow sensor 23. The heat flow in the passive references 18 is measured via the sensor 23 to obtain a differential signal to minimize ambient environmental effects. As with the measurement well sensors 22, the reference well sensors 23 detect heat flow occurring in the reference wells 27 and then convert the heat flow into an electrical signal, which can then be interpreted by a processor into a readable heat flow measurement.

It is noted that the use of a reference signal in difference to the measurement signal is a frequently employed trick in calorimetry. The differential signal attenuates the effects of environmental temperature fluctuations. In order for the reference signal to accurately cancel any environmental artifact signal in the measurement signal, the reference sensor 23 and reference sample 18 must precisely match the measurement sensor 22 and measurement sample 34 with respect to microscopic thermal environment, thermal conductivity, and heat capacity. The last factor is most critical in the case of a temperature scanning measurement where the measurement signal is a direct measure of the apparent difference in heat capacity between the sample 34 and reference materials 18 in the region of a thermally induced reaction, e.g. a phase transition in the sample material.

In the typical differential calorimeter experiment, the reference is matched to the sample by using the same mass of solvent in comparison to a solution sample. If the sample is a very small mass of a liquid or solid material, the reference is often an empty sample pan.

A passive reference sample 18, as shown in FIG. 3, can also be utilized in the present invention. The passive reference 18 is a fixed in place, inert reference mass which is designed to passively match the typical sample of interest. In one embodiment, the reference 18 is an aluminum slug of the appropriate weight to match the heat capacity of the measurement well ampoule holder 32 containing a glass sample vial filled with 0.75 ml of a dilute aqueous solution. It is noted that other suitable fixed reference substances would be apparent to one skilled in the art. While aluminum has been given as a particular example, it is in no way meant to limit the scope of the present invention.

It is also noted that, in some applications of the present invention, it may not even be necessary to include a reference of any kind.

The use of a passive, fixed-in-place reference 18 improves the usability of the array instrument by eliminating the need to prepare and load reference samples 18 which match the measurement sample 34. The use of a fixed reference 18 assembly also allows for unique differential calorimeter assembly configurations. For example, when a fixed reference 18 is utilized, access to the reference well(s) 27 is not needed for insertion of a suitable reference material, therefore the reference 18 can be located beneath its twinned measurement channel.

This unique and innovative geometry which places the reference 18 directly below it's twinned measurement channel 11 is also advantageous in terms of insuring that the reference sensors 23 and measurement sensors 22 are co-located in the same microscopic thermal environment. Another practical benefit of the stacked geometry is that the footprint of the energy array detector will be only one-half the size of a detector with reference wells 27 located on the same block surface as the measurement wells 32.

In one embodiment, the references 18 are permanently attached to the calorimeter block 10. In another embodiment, the references 18 are exchangeable. For example, the fixed reference 18 may have a threaded portion, corresponding to a threaded portion on the calorimeter block 10. In this manner, the reference 18 can be screwed on or off the calorimeter block 10, and replaced as needed.

In the design of the heat flow calorimeter, the thermal conductivity of the TED sensors 22, 23 is the determining factor in the response time. Since the reference sensor 22 and measurement sensors 23 are the same, the thermal conductivity of the sample 34 and reference 18 materials need not be matched. In effect, the rate of change in the calorimetric signal corresponding to production or adsorption of heat within the sample 34 or reference material 18 is almost solely dependent on the thermal conductivity of the slowest responding element in the system which in this case is the heat flow sensor 22, 23 and not the sample 34 or reference material 18. The actual material used as a fixed reference 18 then becomes unimportant as long as the material is thermally stable (inert) over the temperature range of the calorimeter and the typical sample heat capacity can be matched with a reasonable volume of the reference material. The precise matching of the thermal mass (heat capacity) of the sample 34 with the thermal mass (heat capacity) of the reference 18, and the connection of these to the calorimeter block 10 with precisely matched heat flow sensors 22, 23 is all that is required to provide the desired attenuation of environmental thermal noise.

The stacked geometry configuration of FIG. 3 depicts each measurement well 32 as having its own reference well 27 and sensor 23 assembly co-located on the calorimeter block. Moreover, in this embodiment, all of the passive references 18 are identical. However, it is noted that, in other embodiments, the reference signal can be obtained with a single common reference 18 for the entire measurement array or with a dedicated reference 18 for each measurement channel 11. Of course, as noted above, it is desirable that the sample well 32 be in close physical proximity to the reference well 27 such that the sample 34 is experiencing, as much as possible, the same external conditions as the reference 18.

Other embodiments could employ an array of references 18 of differing heat capacity that could be matched on the fly to the individual sample 34 heat capacities. In addition the fixed reference signals could be tuned for sample heat capacity mismatching by changing the amplifier gain for the reference signals, by imposing a variable bucking potential to the reference signals, or by use of a power compensation process to fine tune the matching of the temperature gradients across the reference sensors 23 and sample heat flow sensors 22.

The measurement wells 32 are isolated from each other to minimize cross-talk. Suitable ways to isolate the measurement wells 32 include the following: 1) spacing the wells far enough apart; 2) utilizing a comparatively massive block 10 (relative to a single well/sample); and 3) providing a highly thermally conductive connection between the well 32 and the block 10.

It is noted that the present invention set forth herein is discussed largely in the context of a heat conduction or heat flow calorimeter, wherein the heat flow signal is the voltage developed by the TED sensor 22 in response to any small temperature gradient between the measurement well 32 and the temperature controlled calorimeter block 10. Temperature gradients across the sensor 22 reflect the energetics of a chemical reaction occurring in the measurement well 32. However, it is also noted that the present invention could also make use of either temperature rise (change) or power compensation measurement techniques in addition to the heat flow design.

It is also noted that the present invention is capable of performing both isothermal measurements and temperature scanning measurements. In isothermal measurements, the calorimeter block 10 temperature is controlled, via a solid state temperature control 28, at a constant temperature. This type of measurement would be used for isothermal titration calorimetry. In temperature scanning measurements, the calorimeter block 10 temperature is changed at a constant rate in either the heating or cooling direction. This type of measurement is useful for differential scanning calorimetry experiments.

Other elements depicted in FIG. 3 include coverings 12, 14 substantially over the measurement wells 32 and reference wells 27 for preventing the introduction of air or other external factors into the system. As is well known to those skilled in the art of calorimetry, when measuring heat flow, it is important to prevent the influx of air into the system. Failure to do so can result in compromised measurements.

Numerous materials would be suitable to serve as the insulating coverings 12,14. These materials include, but are not limited to closed cell foams, glass and ceramic fiber based insulation, and/or a vacuum. The top insulating covering 12 is shown placed over the top surface 15 of the calorimeter block 10. The bottom covering 14 is shown placed over the bottom surface 25 of the calorimeter block 10. In this embodiment, both the top 12 and bottom covering 14 are each a single covering. However, it is noted that the coverings 12, 14 could each be a single piece, or more than one smaller coverings could be used for both the top and bottom, provided they adequately insulated the measurement wells 32 and the reference wells 27 from the influx of air.

The heat sink 20 is shown in communication with the solid state temperature control 28, which is in turn coupled to the calorimeter block 10. While the heat sink 20 is particularly identified as that portion of the calorimeter block assembly that serves to provide a reference temperature from which the temperature of the calorimeter block is controlled, it is noted that the entire calorimeter block assembly is often loosely referred to as the “heat sink” since heat flows from the sample to the calorimeter block during an experiment, with the calorimetric signal simply the measurement of this heat flow. It is also important to note that the temperature of the heat sink itself may also be actively controlled, although in FIG. 3 it is shown to be at or near room temperature. The calorimeter block 10 temperature is then controlled to be at a higher (or lower) temperature than the heat sink temperature by the placement of heating (or cooling) elements 28 between the calorimeter block and the heat sink.

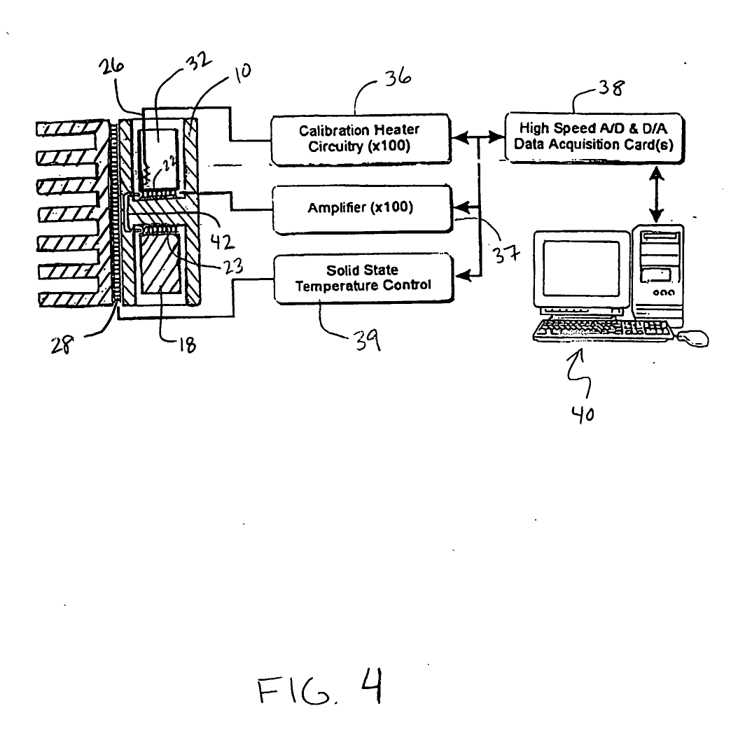

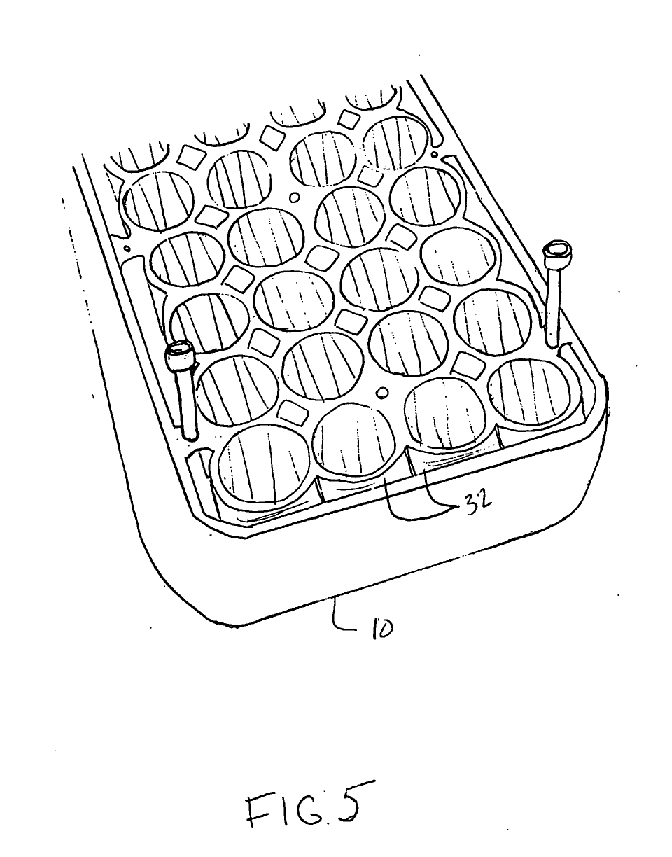

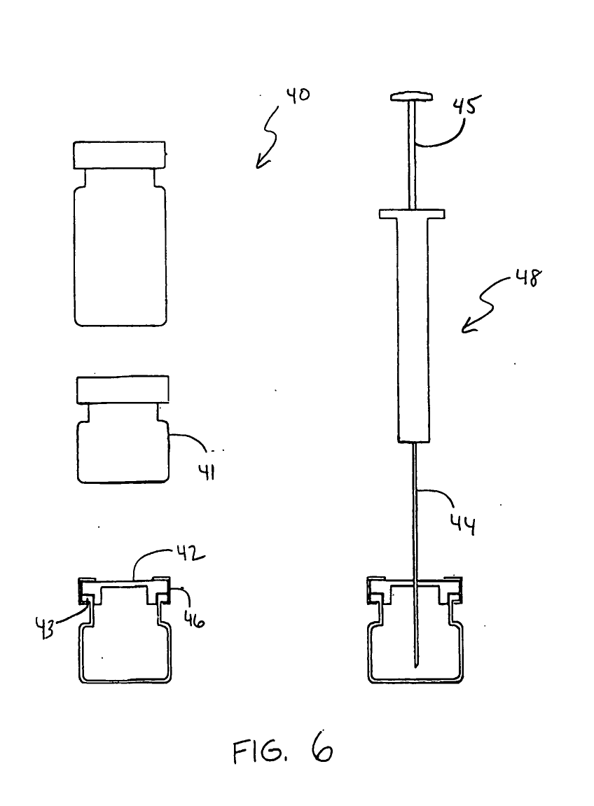

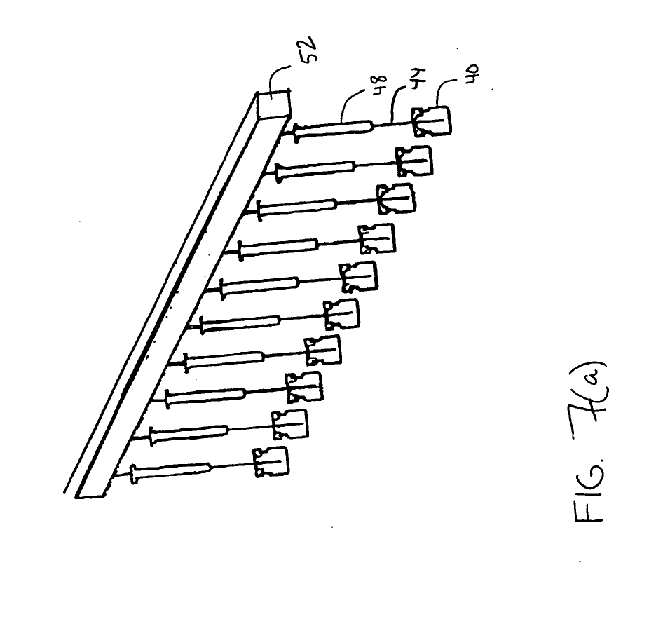

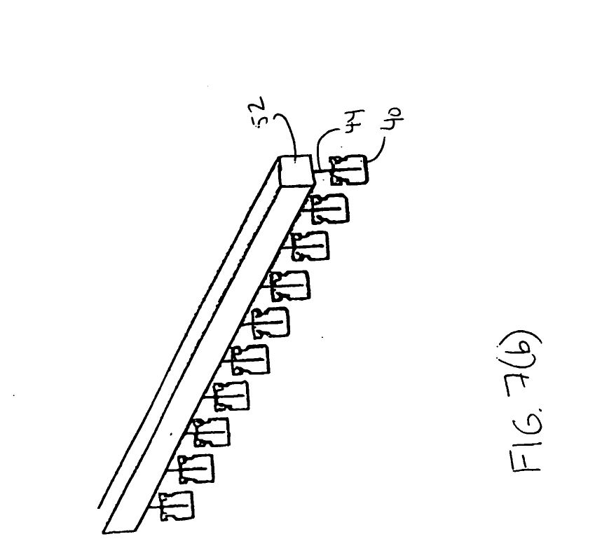

FIG. 4 illustrates, in block diagram, the calibration heater circuitry, for an embodiment of the present invention. Specifically, this diagram illustrates the interaction between the calibration heater 26, and respective circuitry 36, and the amplifier 37 and solid state temperature control 28. An electrical resistance heating element 26 is placed in each sample well so that a known heat pulse can be introduced for the purpose of calibration of the sensor 22 response to a known heat signal. The calibration heater circuitry 36 serves to turn on a stable electrical current for a user specified short period of time. The measured (controlled) electrical current, the measured resistance of the calibration heater, and the duration of the heater pulse, determine the total energy of the calibration signal.

The amplifier 37 serves to boost the differential voltage output (shown schematically) 42 of the TED sensors 22,23 placed between the sample 34 and the block 10 and between the reference 18 and the block 10. In the case of a calibration experiment, the amplified signal corresponds directly to the calibration heat pulse as produced by the control circuitry 36 and the electrical resistance heater 26 placed within the sample cavity 32. The solid state temperature control circuitry 39 provides for the precise temperature control of the calorimeter block 10. As shown in FIG. 4, the temperature control circuitry 39 powers the temperature drive TED modules 28 to either heat the calorimeter block 10 above the heat sink 20 temperature or cool the block 10 temperature below the heat sink 20 temperature. The temperature control circuitry 39 and power elements can either maintain the block 10 temperature at a fixed temperature for isothermal measurements or the temperature control elements 28,39 can be used to scan the temperature of the calorimeter block over a user specified range in temperatures from below to above the heat sink 20 temperature. Although the TED drive elements 28 are shown in FIG. 4, alternative designs could use electrical resistance heating elements either alone or in combination with circuiting liquid coolant or some other combination employing TED elements with electrical heaters and circulating coolant. Each of the measurement and control components 36, 37 and 39 can be controlled through high speed A/D and D/A data acquisition cards 38 installed in a computer system 40.

FIG. 5 shows an embodiment of a calorimeter block 10 with the regular spacing of the measurement wells 32 (sample ampoule holders).

FIG. 6 shows examples of disposable glass vials 40 with a silicone rubber septum seal 42. These vials can be used as the sample ampoules 34 which can be inserted into the measurement wells 32. The septum 42 allows insertion of a needle 44 for titrant injection and stirring while maintaining and adequate seal for temperature scanning experiments at high temperatures. The shortened vial 41 has a standard ringed top 43 which accepts a variety of septum sealing gaskets 42 which are held in place with a crimped in place aluminum cap 46.

It is noted, that the present invention could be built to use other sample containers containing either larger or smaller sample volumes as long as the reference mass or volume was adjusted accordingly. Important factors relevant to the choice of a sample container for use with the present invention are: an absolute seal preventing any loss of solvent at temperatures exceeding the boiling point of the solvent, a seal which can be penetrated with a needle for purposes of titrant addition (or stirring injections), construction from inert materials (e.g. glass, Teflon, silicone rubber, etc.), and having a low cost in the appropriate quantities used. Examples of suitable vials for use with the present invention include, but are not limited to, GC/LC Autosampler Vials, available from Industrial Glassware of Millville, N.J.

It is noted that when multiple samples are being tested, mixing the samples can be problematic (for example, if one hundred samples are being tested, utilization of one hundred different stirrers would be impractical). An advantage to using the septum sealed vials 40 is that they can be used, in conjunction with a syringe 48, to cycle the injector. In other words, in operation, a titrant can be introduced into a sample by injecting a needle 44 through the septum seal and depressing the plunger portion 45 of the syringe 48, thereby depositing the titrant in the vial 40 with the sample. The titrant/sample combination can then be withdrawn from the vial 40 into the syringe 48 and then reinjected back in to the vial 40. In this manner, the titrant/sample combination can be effectively mixed. This process can be repeated in each sample vial 40.

Syringe cycling after each addition of titrant can be used to achieve a homogeneous solution within the sample cell. This mixing can rapidly bring the reaction to equilibrium and produce the reaction heat effect in the shortest time period. Without mixing, any reaction between the contents of the sample cell and added titrant would take place at a rate controlled by diffusion.

Mixing may also be accomplished by means of the hydraulic impulse of a rapid titrant addition through a small injection orifice, by means of repeatedly withdrawing and re-injecting a partial volume of the cell contents after titrant addition, or by creating turbulence by injecting inert gas bubbles under the surface of the liquid within the sample cell. Mixing pulses can be made through the same needle 44 used for titrant addition or through a second mixing injector. In either case, the injectors 48 are inserted into the sample cell through the septum seal 42.

Scanning and titration experiments can both be done with this sort of sample cell. Using these sealed cells also seals in vapor pressure. Loss of vapor pressure significantly alters the output.

Drug or diagnostic agent molecules must bind specifically and tightly to the appropriate receptor site on the target molecule to be effective. The only way to directly measure the specificity and strength of such binding processes without the possibility of perturbing the binding is to use a calorimetric measurement. In an isothermal titration calorimetric measurement (ITC), the energy change accompanying binding is measured directly as the ligand (drug) molecule is added to a solution containing the target (protein or nucleic acid) molecule. In a temperature scanning calorimetric measurement (DSC), the energy change accompanying unfolding of the target molecule in the presence of the ligand molecule is measured. Both ITC and DSC techniques have been widely used to study drug interactions. The present invention can be used in both ITC and DSC protocols. Specifically, the calorimeter block 10 temperature can be controlled at constant temperature to measure isothermal data. The block 10 temperature can also be changed at a constant rate in either the heating or cooling direction for scanning measurements.

With the addition of the means for injecting titrant into each sample cell 40, ITC experiments can be done. These experiments can be done according to a number of protocols depending on the design of the titrant injection system. In the simplest form, one or more stepper motor actuated syringes are robotically translated across the array with titrant injections made through the septum seals 42 of the sample vials 40 in a row 51 or a column 53 of the array (FIGS. 1 and 2) until titrant has been added to all samples in the array. In the fastest protocol, titrant is added simultaneously to all samples in the array.

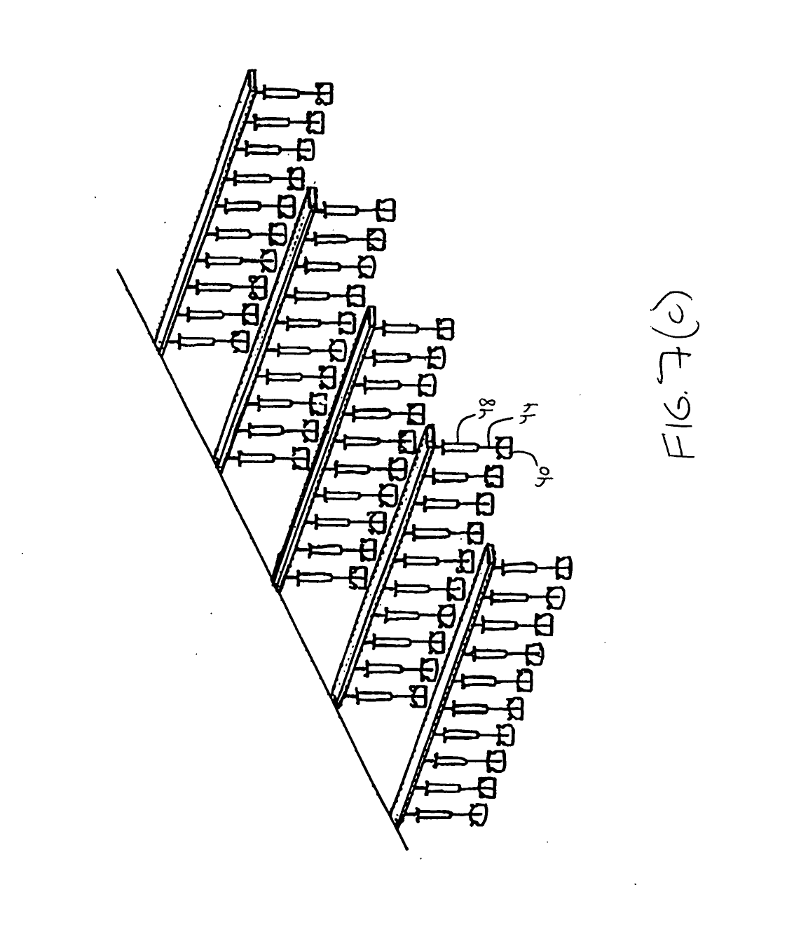

In one embodiment of the present invention titrant delivery can be accomplished by a titrant delivery head 52 equipped with a large number of injectors 48 (FIGS. 7(a) through (c)). This delivery head is able to add titrant to entire rows or columns of sample cells within the array (as in FIGS. 7(a) and 7(b)) or to all sample cells in the array simultaneously (as in FIG. 7(c)).

In another embodiment, the syringes 48 can be replaced with a pump and an array of miniature valves to distribute titrant evenly to all cells within the array. Piezo electric valves, also employed in ink jet printer technology, can be used to distribute the metered titrant to all cells within the array. In each of these cases the titrant is still injected via a needle through the septum seal of the sample vial with the “ink jet” head or pump and valve assembly simply replacing the syringes shown in FIG. 6 and FIG. 7.

In yet another embodiment of the present invention, new “Microfabricated Silicon Thermopiles”, also known as Peltier or Seebeck modules/devices are used as heat flow sensors 22, 23 instead of the solid state thermoelectric devices (TEDs). The new heat flow sensor technology disclosed in U.S. Pat. No. 5,982,014 (entitled Microfabricated Silicon Thermopile Sensor) is particularly well suited for use with the present invention. This patent is hereby incorporated by reference for its supporting teachings.

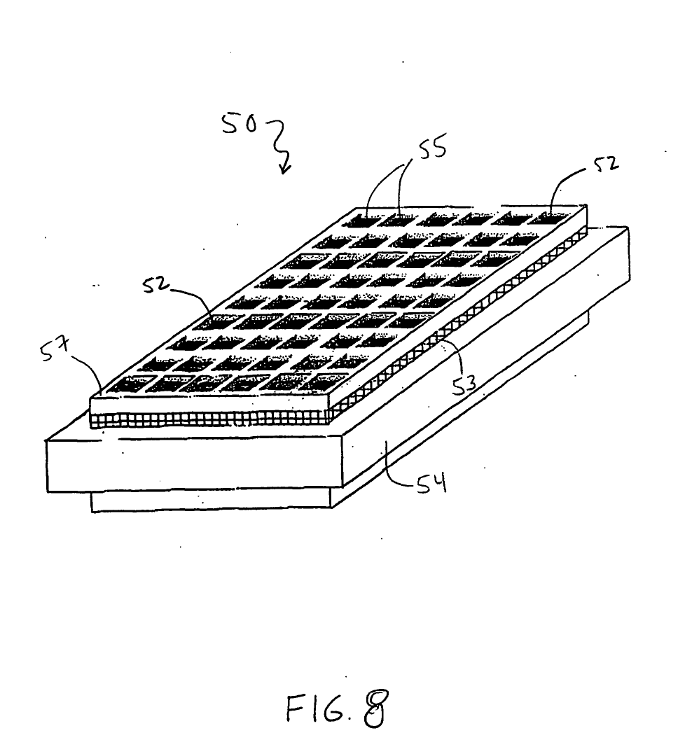

In this embodiment, the microfabricated silicon thermopiles are used as a direct substitute for the sensors 22 discussed above. Additionally, the microfabricated silicon thermopiles could form the basis for a composite monolithic design in which the silicon chip could be fabricated to incorporate an array of sensing spots on a single chip. These thermally responsive spots could be chemically derivitised to yield an array of chemically specific heat flow detectors. In this embodiment, the monolithic array detector could even be a disposable component of the high throughput calorimeter. This technology is illustrated in FIG. 8.

The monolithic sensor 50 is a plurality of TED or thermopiles 52 that are individual sensors which are fused to or embedded in a common inert matrix layer 53. The complete monolithic sensor 50 includes inert mask layers 57 to isolate the individual sample or reference receptacles 55, two sensor matrix layers (not shown), and the miniature integrated calorimeter block or base 54. Target molecules can be directly linked to the surface of each thermally responsive area of the chip in a corresponding receptacle 55. Then the chemical reaction can be done directly on the chip. In a manner similar to that outlined above, the heat flow from this reaction can then be measured by the embedded sample and reference sensors as the reaction heat flows to the central block, or base 54. of the monolithic array.

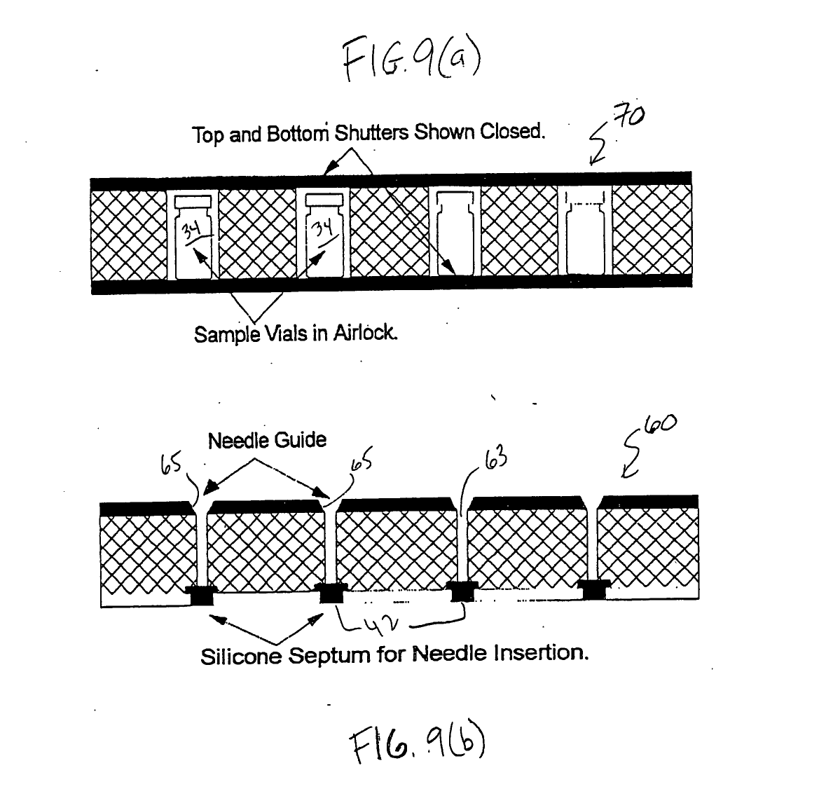

FIGS. 9(a)-(b) show examples of other types of insulating coverings 12, 14 that can be used with the present invention. In FIG. 9(a), an airlock covering 70 is depicted. In FIG. 9(b), an injection port lid 60 is depicted.

The injection port lid 60 is useful in embodiments incorporating titrant injection (as depicted in FIGS. 6 and 7(a)-(c)). For example, when titrant injection is used to introduce a reagent into a sample ampoule (not shown), the injection port lid 60 guides the injection needle 44 through the guiding channels 63 and into the septum seal 42 of the desired sample vial 41 (FIG. 6). The sloped edges 65 of the guiding channels also help correct any slight deviations in the trajectory of the injector 48.

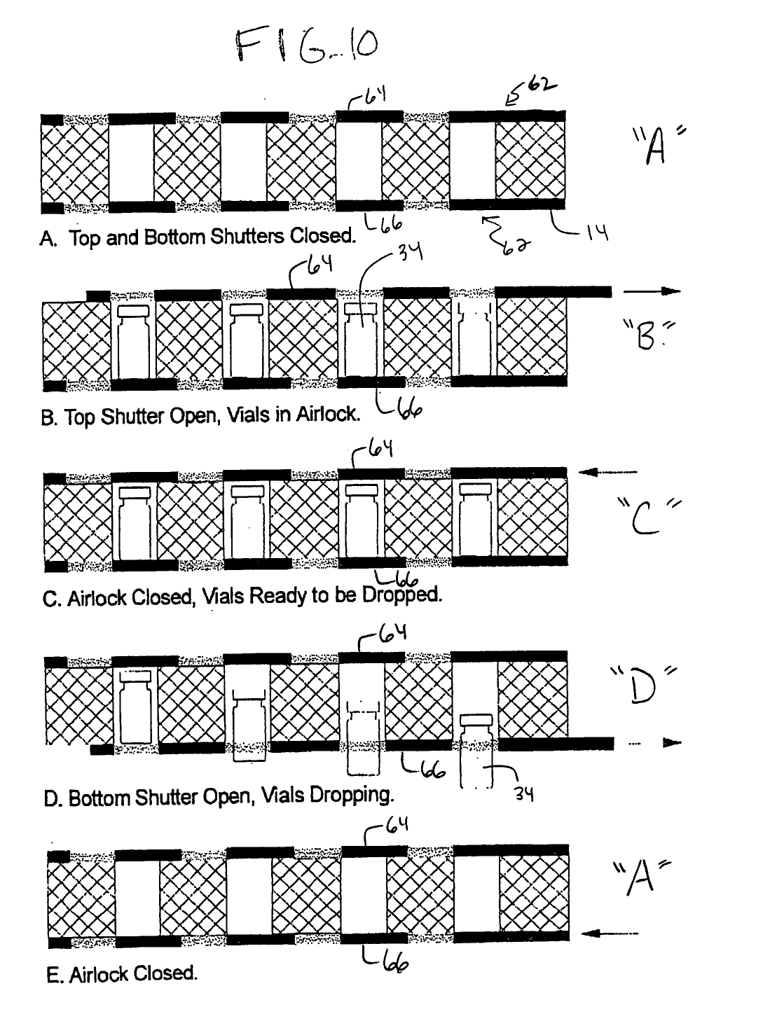

The airlock covering 70, as best seen in FIG. 10, allows samples 34 to be introduced into the measurement wells 32 with minimal influx of air into the system. To illustrate, in position “A”, the top shutters 64 and bottom shutters 66 are in a closed position. Thus, air is prevented from entering the measurement channels 11 and corresponding measurement wells 32 (not shown). In position “B”, the top shutters 64 open allowing a user to insert a sample 34. The bottom shutters 66 remain closed, thereby substantially preventing air from entering the system. In position “C”, the top shutters 64 close, thereby closing the airlock. In position “D”, the bottom shutters 66 open, thus depositing the sample 34 into the appropriate measurement well 32. The bottom shutters 66 subsequently close to position “A.”

It is noted that while particular mention has been made with respect to using the present invention in the context of drug development, etc., it could also be used in any field of science that would employ calorimetry-such as determination of shelf life of pharmaceuticals, chemical compatibility, purity of materials, stability of propellants and explosives, and shelf life of batteries. It also has application in the paper industry and film industry. Therefore, while the foregoing application makes particular mention of the present invention in the context of genomic and proteomic research, such uses are given only as examples, and are not meant to limit the scope of the invention in any way.

Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function, manner of operation, assembly, and use may be made without departing from the principles and concepts set forth herein.

1. A device for measuring heat flow from a first, second and third sample, comprising:
a) a sample array, including:
i) a base;
ii) a first receptacle, capable of containing the first sample, coupled to the base;
iii) a second receptacle, capable of containing the second sample, coupled to the base;
iv) a third receptacle, capable of containing a third sample, coupled to the base;
v) a first sensor, in communication with the first receptacle, which detects a first heat flow from the first sample and converts the first heat flow into a first electronic signal;
vi) a second sensor, in communication with the second receptacle, which detects a second heat flow from the second sample and converts the second heat flow into a second electronic signal; and
vii) a third sensor, in communication with the third receptacle, which detects a third heat flow from the third sample and converts the third heat flow into a third electronic signal;
b) one or more covers, positioned substantially over the first, second and third receptacles, that substantially prevents the influx of air into the first, second and third receptacles; and
c) a processor, in communication with the first, second and third sensors; which receives the first, second and third electronic signals and converts the first, second and third electronic signals into a readable measurement of heat flow in the first, second and third sample.

2. The device of claim 1, wherein the first and second samples are test samples and the third sample is a reference sample.

3. The device of claim 1, wherein the first, second and third samples are all test samples.

4. The device of claim 1, wherein the first and second receptacles are coupled to a first side of the base, and the third receptacle is coupled to a second side of the base, opposite the first side.

5. The device of claim 1, wherein the first, second and third sensors are solid state thermoelectric device (TED) heat flow sensors.

6. The device of claim 1, wherein the first, second and third sensors are silicone thermopiles.

7. The device of claim 1, wherein the first heat flow occurs due to a chemical reaction.

8. The device of claim 1, wherein the first heat flow occurs due to a phase change.

9. A calorimeter sample measurement array comprising:
a) a base;
b) a first receptacle, capable of containing a first sample, coupled to the base;
c) a second receptacle, capable of containing a second sample, coupled to the base;
d) a third receptacle, capable of containing a third sample, coupled to the base;
e) a first sensor, in communication with the first receptacle;
f) a second sensor, in communication with the second receptacle; and
g) a third sensor, in communication with the third receptacle; wherein the first sensor detects a first heat flow from the first sample, occurring in the first receptacle, the second sensor detects second heat flow from the second sample, occurring in the second receptacle, and the third sensor detects a third heat flow from the third sample, occurring in the third receptacle.

10. The array of claim 9, wherein the first and second samples are test samples and the third sample is a reference sample.

11. The array of claim 9, wherein the first, second and third samples are all test samples.

12. The array of claim 9, wherein the first and second receptacles are coupled to a first side of the base, and the third receptacle is coupled to a second side of the base, opposite the first side.

13. The array of claim 9, wherein the first, second and third sensors are solid state thermoelectric device (TED) heat flow sensors.

14. The array of claim 9, wherein the first, second and third sensors are silicone thermopiles.

15. A method of measuring heat flow from a first, second and third sample, comprising the steps of:
a) providing a sample array, including:
i) a base;
ii) a first receptacle, capable of containing the first sample, coupled to the base;
iii) a second receptacle, capable of containing the second sample, coupled to the base;
iv) a third receptacle, capable of containing a third sample, coupled to the base;
v) a first sensor, in communication with the first receptacle, which detects a first heat flow from the first sample and converts the first heat flow into a first electronic signal;
vi) a second sensor, in communication with the second receptacle, which detects a second heat flow from the second sample and converts the second heat flow into a second electronic signal; and
vii) a third sensor, in communication with the third receptacle, which detects a third heat flow from the third sample and converts the third heat flow into a third electronic signal;
b) introducing the first sample into the first receptacle;
c) introducing the second sample into the second receptacle;
d) introducing the third sample into the third receptacle;
e) covering the first, second and third receptacles, such that the first, second and third receptacles are substantially protected from an influx of air;
f) detecting a first heat flow from the first sample with the first sensor;
g) converting the first heat flow detected by the first sensor into a first electronic signal;
h) processing the first electronic signal into a first readable heat flow measurement;
i) detecting a second heat flow from the second sample with the second sensor;
j) converting the second heat flow detected by the second sensor into a second electronic signal;
k) processing the second electronic signal into a second readable heat flow measurement;
l) detecting a third heat flow from the third sample with the third sensor;
m) converting the third heat flow detected by the third sensor into a third electronic signal;
n) processing the third electronic signal into a third readable heat flow measurement.

16. The method of claim 15, wherein the first and second samples are test samples and the third sample is a reference sample.

17. The method of claim 15, wherein the first and second receptacles are coupled to a first side of the base, and the third receptacle is coupled to a second side of the base, opposite the first side.

18. The method of claim 15, wherein the first sample is introduced to the first receptacle by injection through a titrant delivery head.

19. The method of claim 15, wherein the first, second and third sensors are solid state thermoelectric device (TED) heat flow sensors.

20. The method of claim 15, wherein the first, second and third sensors are silicone thermopiles.
